(19) United States
(12) Patent Application Publication
(10) Pub. No.: US 2015/0371196 A1
(43) Pub. Date: Dec. 24, 2015

(54) METHOD, SYSTEM, AND NON-TRANSITORY RECORDING MEDIUM FOR MEETING PLACE RECOMMENDATION USING LOCATIONS AND PREFERENCES OF USERS AND FILE DISTRIBUTION SYSTEM

(71) Applicant: NAVER Corporation, Seongnam-si (KR)

(72) Inventor: YungSeong Lee, Seongnam-si (KR)

(21) Appl. No.: 14/742,152

(22) Filed: Jun. 17, 2015

(30) Foreign Application Priority Data
Jun. 18, 2014 (KR) 10-2014-0074467

(51) Int. Cl. G06Q 10/10; G06Q 50/00

(52) U.S. Cl. CPC G06Q 10/1095; G06Q 50/01

(57) ABSTRACT

A method and system for recommending a meeting place using locations and preferences of a plurality of users include providing, by a provider included in a processor, a meeting appointment function for setting an offline meeting between a plurality of users having set a relationship on a closed-type social network service (SNS); and recommending, by a recommender included in the processor, a region, a business type, and a store for the offline meeting based on location information and preference information of the users through the meeting appointment function.

### CROSS-REFERENCE TO RELATED APPLICATION

This application claims priority from and the benefit of Korean Patent Application No. 10-2014-0074467, filed on Jun. 18, 2014, the disclosure of which is incorporated herein its entirety by reference.

### BACKGROUND

1. Field

Example embodiments of the present invention relate to a method, system, and non-transitory recording medium for recommending a meeting place using locations and preferences of a plurality of users.

2. Description of the Background

With the recent spread of mobile and ubiquitous infrastructures, a variety of services are being evolved into individual customized services.

A customized service according to the related art provides products or information around a user based on location information or preference information of the user.

For example, Korean Laid-Open Publication No. 10-2012-0061206, published on Jun. 13, 2012, discloses a technology for providing information regarding how to go to an appointed place based on locations of users having set an appointment.

An existing service for searching for a place based on location remains at a level of providing search results based on a region corresponding to the location or supporting category browsing.

### SUMMARY

Some example embodiments of the present invention provide a method and system capable of recommending an appropriate business type and store by applying locations and preferences of expected attending members when appointing an offline meeting place through a closed-type social network service (SNS).

Some example embodiments provide a method and system capable of extracting a meeting related keyword from a chat room or a bulletin board on a closed-type SNS and automatically pushing a meeting appointment function.

Some example embodiments provide a method and system capable of determining business stores by recommendation and displaying the stores in order of bid prices using a reverse auction method.

Some example embodiments provide a method and system capable of sharing a portion of a bid price with an organizer of a meeting or a closed-type SNS in response to an occurrence of sales.

According to at least one example embodiment, there is provided a meeting place recommendation method performed by a meeting place recommendation system, wherein the meeting place recommendation system includes a processor and the processor includes a provider and a recommender, and the meeting place recommendation method includes providing, by the provider included in the processor, a meeting appointment function capable of setting an offline meeting between a plurality of users having set a relationship on a closed-type social network service (SNS), and recommending, by the recommender included in the processor, a region, a business type, and a store for the offline meeting based on location information and preference information of the plurality of users through the meeting appointment function.

The providing may include pushing the meeting appointment function to a user having input a meeting related keyword in response to extracting the meeting related keyword from keywords input on a chat room or a bulletin board on the closed-type SNS.

The providing may include providing each user with the meeting appointment function that includes a function of inputting attendance information including a departure location, a preferred business type, and a non-preferred business type.

The recommending may include recommending the region, the business type, and the store for the offline meeting based on location information and preference information of an expected attendee having registered an intent to attend the offline meeting among the plurality of users.

The recommending may include recommending the region based on a current location of each user or an expected location corresponding to an appointed time of the offline meeting extracted from a location record log of each user, with respect to the plurality of users.

The recommending may include calculating a centroid location between departure locations with respect to the users and recommending one or more spots adjacent to the centroid location.

The recommending may include recommending one of spots based on at least one of a travel distance from a departure location of each user to a spot and a travel distance from the spot to a return-home location of each user.

The recommending may include receiving a selection from each user on a preferred business type and a non-preferred business type, excluding non-preferred business types, and recommending preferred business types in order of weights based on selection counts.

The recommending may include recommending the business type based on season information corresponding to an appointed time of the offline meeting.

The recommending may include extracting stores corresponding to a region by recommendation and a business type by recommendation and displaying the extracted stores in order of bid prices.

The recommending may include transmitting information about the offline meeting to the extracted stores, and displaying a store having applied for a bid associated with the offline meeting using a reverse auction method.

The recommending may include transmitting information about the offline meeting to the extracted stores, receiving a response regarding whether booking of the offline meeting is available, and displaying stores at which booking of the offline meeting is available.

The processor may further include a manager, and the meeting place recommendation method may further include registering, by the manager included in the processor, the offline meeting as a schedule associated with the closed-type SNS in response to the offline meeting booked at a desired store.

The processor may further include a manager, and the meeting place recommendation method may further include transmitting, by the manager included in the processor, information about the offline meeting to a store at which the offline meeting is booked among the displayed stores, and transmitting, to remaining stores, drop information including a bid price of the store at which the offline meeting is booked.

The processor may further include a profit sharer, and the meeting place recommendation method may further include sharing, by the profit sharer included in the processor, a portion of a bid price of a store at which the offline meeting is booked with at least one of the closed-type SNS and an organizer having set the offline meeting.

The sharing may include saving the portion of the bid price in response to uploading meeting day authentication information that maps the store at which the offline meeting is booked.

According to at least on example embodiment, there is provided a non-transitory computer-readable medium including an instruction to control a computer system to provide a closed-type SNS, wherein the instruction controls the computer system by a method including providing a meeting appointment function capable of setting an offline meeting between a plurality of users having set a relationship on the closed-type SNS, and recommending a region, a business type, and a store for the offline meeting based on location information and preference information of the plurality of users through the meeting appointment function.

According to at least on example embodiment, there is provided a meeting place recommendation system including a processor, a memory, and a network interface, wherein the processor includes a provider configured to provide a meeting appointment function capable of setting an offline meeting between a plurality of users having set a relationship on a closed-type SNS, and a recommender configured to recommend a region, a business type, and a store for the offline meeting based on location information and preference information of the plurality of users through the meeting appointment function.

The provider may be configured to push the meeting appointment function to a user having input a meeting related keyword in response to extracting the meeting related keyword from keywords input on a chat room or a bulletin board on the closed-type SNS.

The provider may be configured to provide each user with the meeting appointment function that includes a function of inputting attendance information including a departure location, a preferred business type, and a non-preferred business type.

It is to be understood that both the foregoing general description and the following detailed description are explanatory and are intended to provide further explanation of the example embodiments as claimed.

According to at least one example embodiment, it is possible to recommend an appropriate region, business type, and store by applying locations and preferences of expected attending members when making an appointment of an offline meeting through a closed-type SNS.

Also, according to at least one example embodiment, it is possible to extract a meeting related keyword from a chat room or a bulletin board on a closed-type SNS and automatically push a meeting appointment function.

Also, according to at least one example embodiment, it is possible to determine stores by recommendation and to display the stores in order of bid prices using a reverse auction method.

Also, according to at least one example embodiment, it is possible to share a portion of a bid price with an organizer of a meeting or a closed-type SNS in response to an occurrence of sales.

### BRIEF DESCRIPTION OF THE DRAWINGS

The foregoing and other features of the example embodiments of the present invention will be apparent from the more particular description of non-limiting embodiments, as illustrated in the accompanying drawings in which like reference characters refer to like parts throughout the different views. The drawings are not necessarily to scale, emphasis instead being placed upon illustrating principles of inventive concepts. In the drawings:

FIG. 1 is a diagram illustrating an example of a meeting place recommendation service environment according to one example embodiment.

FIG. 2 is a block diagram illustrating a configuration of a meeting place recommendation system according to one example embodiment.

FIG. 3 is a flowchart illustrating a meeting place recommendation method according to one example embodiment.

FIG. 4 is a flowchart illustrating a process of providing a meeting appointment function according to one example embodiment.

FIGS. 5 and 6 illustrate examples of a path of a meeting appointment function according to one embodiment.

FIG. 7 illustrates an example of inputting a preferred business type and a non-preferred business type as preference information of a user according to one embodiment.

FIG. 8 is a flowchart illustrating a process of recommending regions for an offline meeting according to one example embodiment.

FIG. 9 illustrates an example of an inter-user centroid location according to one embodiment.

FIG. 10 is a flowchart illustrating a process of recommending regions for an offline meeting based on public transportation according to one example embodiment.

FIG. 11 is a flowchart illustrating a process of recommending business types for an offline meeting according to one example embodiment.

FIG. 12 is a flowchart illustrating a process of recommending stores for an offline meeting according to one example embodiment.

FIG. 13 is a flowchart illustrating a process of managing an offline meeting and stores by recommendation according to one example embodiment.

FIG. 14 is a flowchart illustrating a process of sharing profits made in response to recommending a store according to one example embodiment.

FIG. 15 is a block diagram illustrating a configuration of a computer system according to at least one example embodiment.

### DETAILED DESCRIPTION

Example embodiments of the present invention will now be described more fully with reference to the accompanying drawings, in which some example embodiments are shown. Example embodiments, may, however, be embodied in many different forms and should not be construed as being limited to the embodiments set forth herein; rather, these example embodiments are provided so that this disclosure will be thorough and complete, and will fully convey the scope of the example embodiments to those of ordinary skill in the art. In the drawings, the thicknesses of layers and regions are exaggerated for clarity. Like reference characters and/or numerals in the drawings denote like elements, and thus their description may be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”). As used herein the term “and/or” includes any and all combinations of one or more of the associated listed items.

It will be understood that, although the terms “first”, “second”, etc. may be used herein to describe various elements, components, regions, layers and/or sections. These elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof Expressions such as “at least one of,” when preceding a list of elements, modify the entire list of elements and do not modify the individual elements of the list.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein

Hereinafter, example embodiments will be described with reference to the accompanying drawings.

The example embodiments relate to providing a service that recommends regions, business types, and stores for a meeting place by applying locations and preferences of a plurality of users.

Herein, the term “closed-type social network service (SNS)” relates to an SNS service where only invited members can join, communicate and share contents, and may indicate a community unit that communicates with a limited small group.

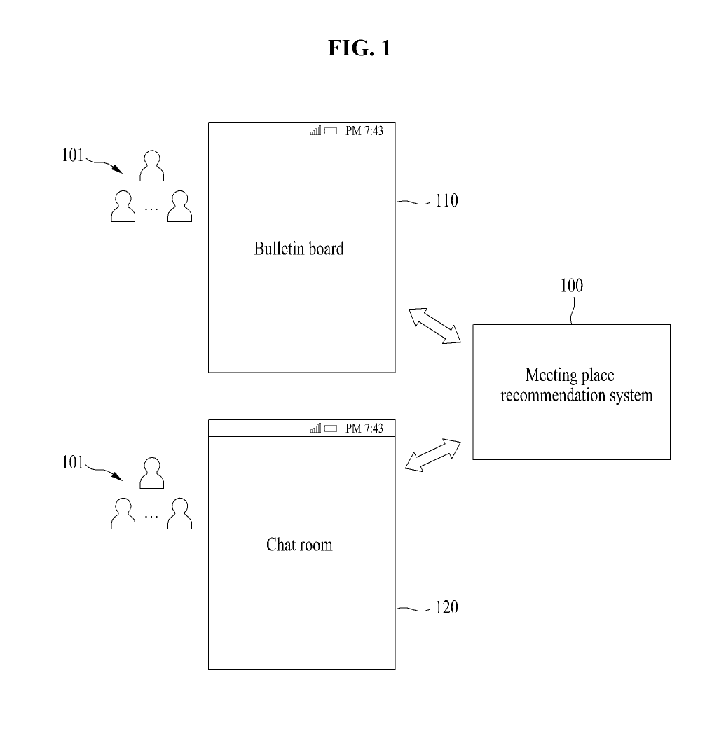

FIG. 1 is a diagram illustrating an example of a meeting place recommendation service environment according to one example embodiment. FIG. 1 illustrates a plurality of users 101 and a meeting place recommendation system 100. Here, the users 101 may refer to terminals used by the users 101. In FIG. 1, arrow indicators indicate that data may be transmitted and received between the plurality of users 101 and the meeting place recommendation system 100 over a wired/wireless network.

The terminals used by the users 101 may be any type of terminal devices, such as a personal computer (PC), a laptop computer, a smartphone, or a tablet, capable of installing and executing a closed-type SNS application that is a service exclusive application associated with the meeting place recommendation system 100. Here, the terminals used by the users 101 may perform the overall service operation, such as a service screen configuration, a data input, a data transmission and reception, and a data storage under the control of the closed-type SNS application.

The meeting place recommendation system 100 provides a meeting place recommendation service for recommending an appropriate meeting place based on locations of the users 101 having set an appointment on a closed-type SNS through an SNS platform. That is, the meeting place recommendation system 100 provides a meeting appointment function capable of setting an offline meeting between the users 101 having installed a closed-type SNS application. Here, the closed-type SNS application may include basic SNS functions, for example, a bulletin board, a chat room, a photo gallery including videos and photos, and a calendar for schedule management, and may also include the meeting appointment function for an offline meeting. For example, the meeting appointment function may be associated with at least a portion of functions of the closed-type SNS application and may be provided through a bulletin board 110 and a chat room 120.

Hereinafter, an operation of the meeting place recommendation system 100 will be further described.

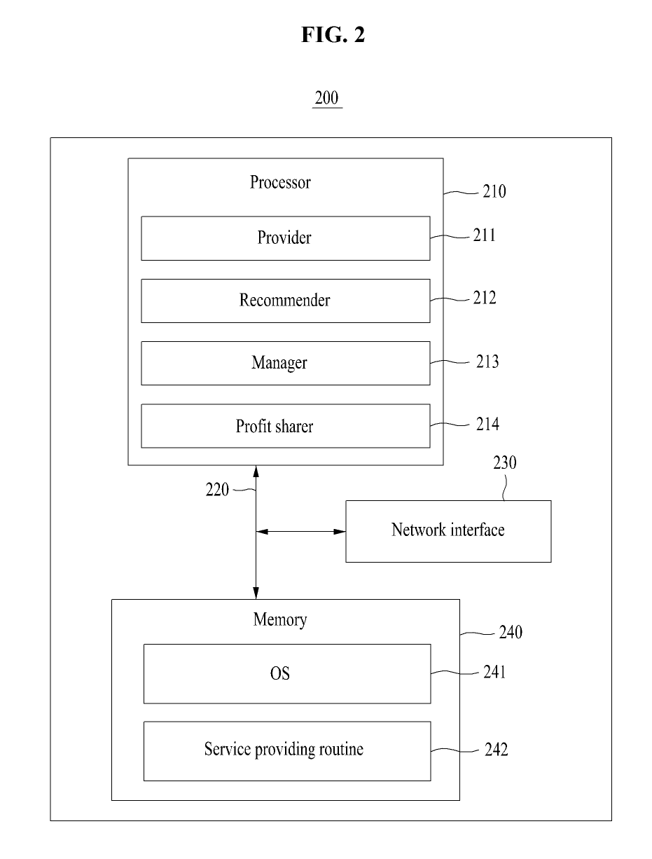

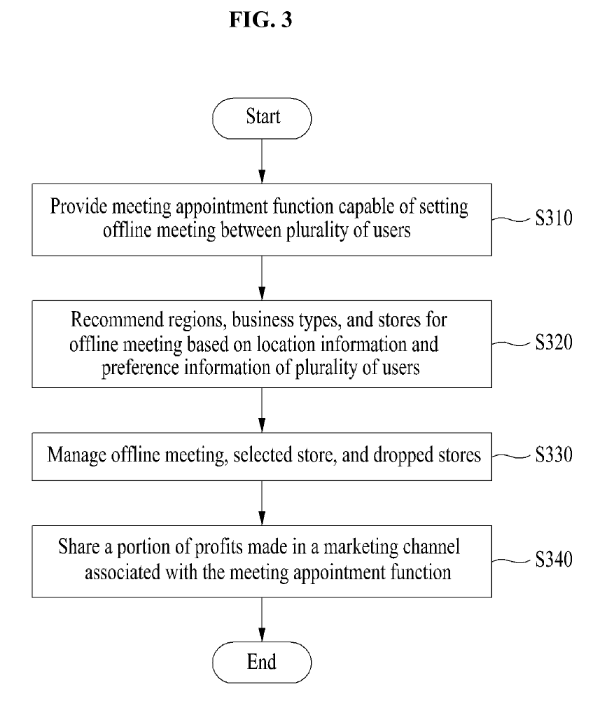

FIG. 2 is a block diagram illustrating a configuration of a meeting place recommendation system according to one example embodiment, and FIG. 3 is a flowchart illustrating a meeting place recommendation method according to an example embodiment.

Referring to FIG. 2, the meeting place recommendation system 200 includes a processor 210, a bus 220, a network interface 230, and a memory 240. The memory 240 includes an operating system (OS) 241 and a service providing routine 242. The processor 210 includes a provider 211, a recommender 212, a manager 213, and a profit sharer 214. According to other example embodiments, the meeting place recommendation system 200 may include more number of constituent elements or units than the number of constituent elements or units shown in FIG. 2.

The memory 240 may include a permanent mass storage device, such as a random access memory (RAM), a read only memory (ROM), and a disc drive, as a computer-readable storage medium. Also, a program code for the OS 241 and the service providing routine 242 may be stored in the memory 240. Such software constituent elements may be loaded from another computer-readable storage medium separate from the memory 240 using a drive mechanism (not shown). The other computer-readable storage medium may include, for example, a floppy drive, a disc, a tape, a DVD/CD-ROM drive, and a memory card. Software constituent elements may be loaded to the memory 240 through the network interface 230 instead of using the computer-readable storage medium.

The bus 220 enables communication and data transmission between the constituent elements of the meeting place recommendation system 200. The bus 220 may be configured using a high-speed serial bus, a parallel bus, a storage area network (SAN), and/or another appropriate communication technology.

The network interface 230 may be a computer hardware constituent element for connecting the meeting place recommendation system 200 to the computer network. The network interface 230 may connect the meeting place recommendation system 200 to the computer network through a wireless or wired connection.

The processor 210 is configured to process computer-readable instructions of, for example, a computer program by performing a basic arithmetic and logic operation, and an input/output (I/O) operation of the meeting place recommendation system 200. The computer-readable instructions may be provided from the memory 240 or the network interface 230 to the processor 210 through the bus 220. The processor 210 may be configured to execute the computer readable instructions as one or more program codes for the provider 211, the recommender 212, the manager 213, and the profit sharer 214. The program code may be stored in a storage device such as the memory 240.

The provider 211, the recommender 212, the manager 213, and the profit sharer 214 are elements or units of the processor 210 and are configured to perform operations S310 through S340 of FIG. 3. Each unit of the processor 210 may be a dedicated hardware portion of the processor 200 performing its designated operation, or they may be particular functional operations which are performed by the processor itself.

In operation S310, the provider 211 provides a meeting appointment function capable of setting an offline meeting between a plurality of users having set a relationship on a closed-type SNS. Here, the provider 211 may serve to support a portion of functions of the closed-type SNS to be used as the meeting appointment function on the closed-type SNS. For example, the provider 211 may provide a user interface (UI) for analyzing a post or a chat message on the closed-type SNS and executing the meeting appointment function based on presence of a meeting related keyword.

In operation S320, the recommender 212 recommends regions, business types, and stores for the offline meeting based on location information and preference information of the plurality of users through the meeting appointment function. Here, the recommender 212 may recommend a meeting place of the offline meeting by applying a location and a preference of an expected attendee having registered an intent to attend the offline meeting among the plurality of users that are members of the closed-type SNS. The intent to attend the offline meeting may be identified using a direct input method for directly receiving the intent from each user and an indirect input method for automatically registering a user having participated in a vote for setting a date of the offline meeting as an expected attendee.

In operation S330, the manager 213 manages the offline meeting set on the closed-type SNS, and manages the store at which the offline meeting is booked and dropped stores that are remaining stores, among the stores recommended for the offline meeting. For example, when a desired (or, alternatively predetermined) store is booked as a meeting place of the offline meeting among stores by recommendation, the manager 213 registers and thereby manage the booked offline meeting in a schedule of the closed-type SNS. When the offline meeting is registered in the schedule, the manager 213 may push, to expected attendees, a notification that the offline meeting is registered and the appointed time of the meeting. As another example, the manager 213 may manage performance, for example, recommendation counts, selection counts, and drop counts, for each store based on recommendations and bookings for offline meetings.

In operation S340, the profit sharer 214 shares, with at least one of the closed-type

SNS and an organizer having set the offline meeting, a portion of profits made in response to a user action such as using information about a recommended store or a call such as a call connection, or booking of the offline meeting. That is, the profit sharer 214 may save a portion of profits made in a marketing channel associated with the meeting appointment function based on an individual, for example, a meeting organizer having used the meeting appointment function to set the offline meeting or a corresponding community unit that is the closed-type SNS itself.

Hereinafter, a process of providing the meeting appointment function will be described.

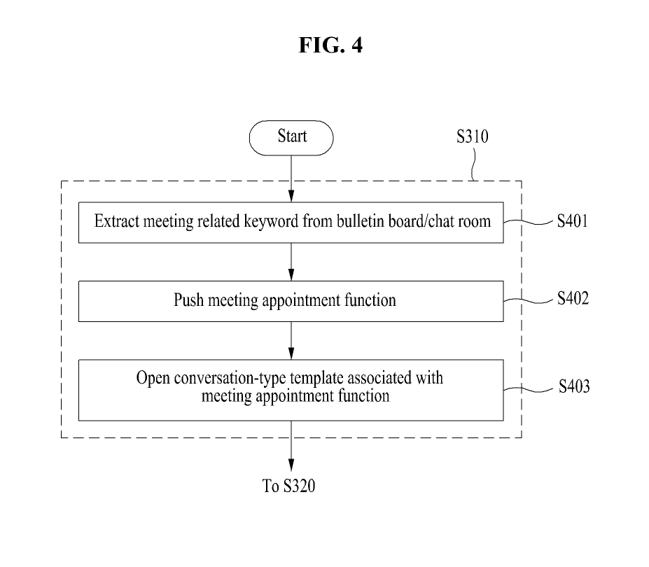

FIG. 4 is a flowchart illustrating a process of providing a meeting appointment function according to one example embodiment. Operations S401 through S403 of FIG. 4 are performed by the provider 211 of FIG. 2.

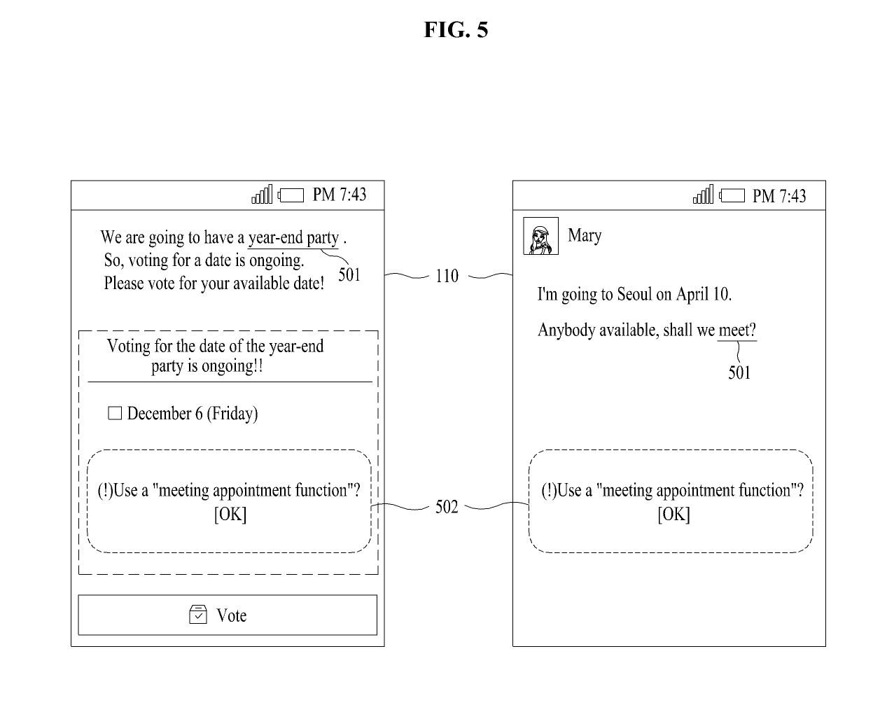

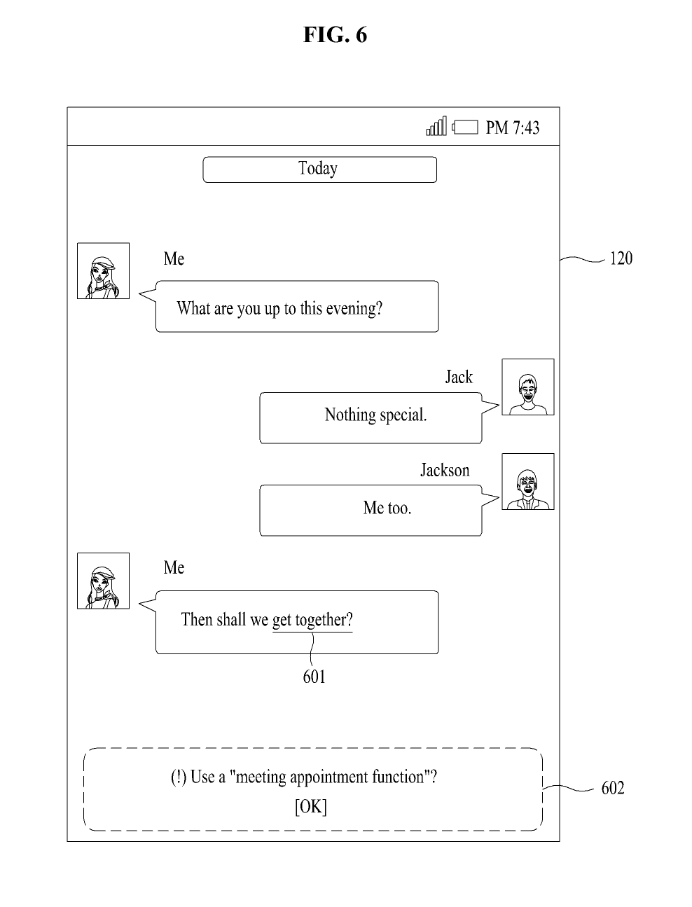

In operation S401, the provider 211 analyzes a post or a chat message on a closed-type SNS and determines whether a term corresponding to an input keyword dictionary is present in the post or the chat message. Here, the input keyword dictionary includes keywords for determining whether the meeting appointment function is used, and may be configured by selecting, for example, keywords “meet” and “get along together” as meeting related keywords. As an example, referring to FIG. 5, the provider 211 may extract a meeting related keyword 501 from a text posted on a bulletin board 110 of the closed-type SNS. As another example, referring to FIG. 6, the provider 211 may extract a meeting related keyword 601 from a conversation message exchanged between users on a chat room 120 of the closed-type SNS.

In operation S402, when the meeting related keyword is extracted from the post or the chat message on the closed-type SNS, the provider 211 pushes or recommends the use of the meeting appointment function to a user having input the meeting related keyword. As an example, when the meeting related keyword is extracted from the post or the chat message on the closed-type SNS, the provider 211 may provide a notification 502, as illustrated in FIG. 5, for recommending a poster of the post including the meeting related keyword to use the meeting appointment function through a system alert or a popup. As another example, the provider 211 may provide a notification 602, as illustrated in FIG. 6, for recommending a user transmitting the meeting related keyword to use the meeting appointment function on a conversation window of the user.

In operation S403, when the user (hereinafter, an organizer) having input the meeting related keyword accepts the meeting appointment function, the provider 211 opens a conversation-type template associated with the meeting appointment function. Here, the conversation-type template of the meeting appointment function may include a function of inputting basic information that includes a user (hereinafter, an attending member) that is to attend the offline meeting and an appointed time, for example, a date and a time, of the offline meeting. When the meeting appointment function is used through a bulletin board of the closed-type SNS in a state in which an appointed time with the attending member is set, information about the attending member and the appointed time may be read from the bulletin board and an input of corresponding information may be omitted. The conversation-type template of the meeting appointment function may include a function of inputting attendance information that includes a departure location, a preferred business type, and a non-preferred business type for each attending member. Accordingly, the provider 211 may push an alert or a popup for requesting an input of attendance information to all of the tending members of the offline meeting, and may receive attendance information from each attending member.

The conversation-type template of the meeting appointment function may include a function of inputting a current location of an attending member as a departure location as a basic setting. As another example, the conversation-type template of the meeting appointment function may include a function that allows an attending member to directly input a departure location through a map search or an address input. As another example, the conversation-type template of the meeting appointment function may include a function of automatically setting a departure location using a location recording log for each attending member. In the closed-type SNS, a location recording log in which a location of a user is periodically collected and recorded may be secured with respect to the user having allowed a location access. Accordingly, the provider 211 may automatically set a departure location of an attending member using the location recording log. That is, the provider 211 may extract an expected location corresponding to the appointed time of the offline meeting from the location recording log of the attending member and may set the extracted expected location as a departure location of the attending member. As described above, using the location recording log, it is possible to determine a departure location of a user by verifying a location of the user for each time and determining an office and a residential area. Also, it is possible to determine a departure location of a user based on whether an appointed time of an offline meeting is weekend or weekday. As another example, the conversation-type template of the meeting appointment function may include a function of inputting a departure location and a return-home location after the offline meeting. Here, the return-home location may be set using a direct input method of an attending member using a map search or an address input or an automatic input method using a location recording log.

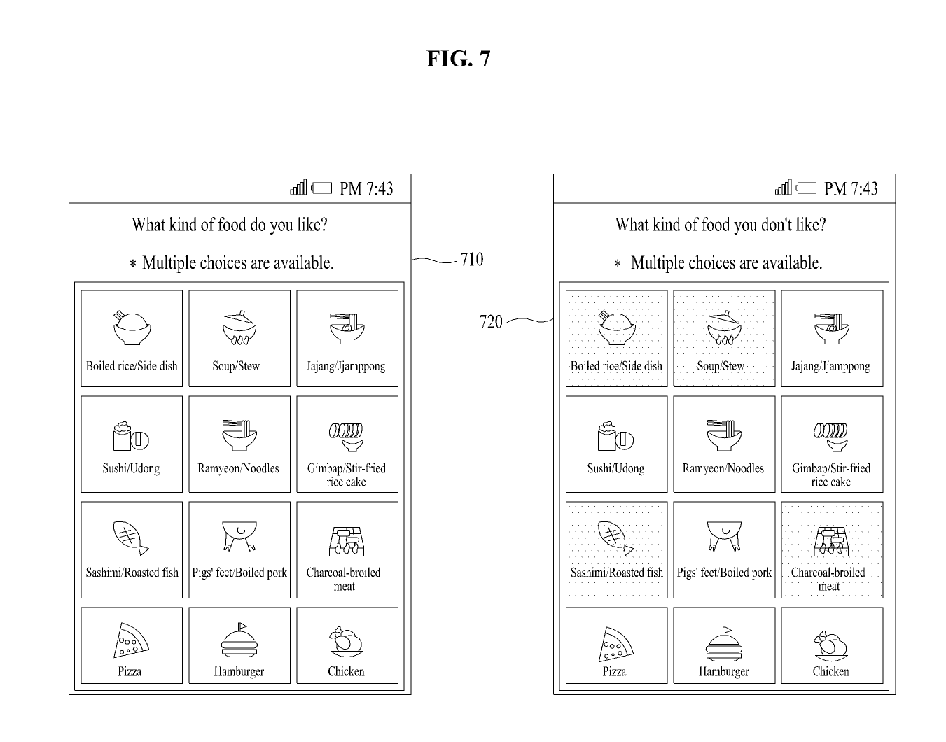

The provider 211 may receive a selection on a preferred business type and a non-preferred business type from each attending member, in order to apply personal preferences of attending members to recommend a meeting place. For example, referring to FIG. 7, the provider 211 may sequentially provide a preferred business type selection template 710 and a non-preferred business type selection template 720 and may receive a selection on a preferred business type and a non-preferred business type from each attending member through the preferred business type selection template 710 and the non-preferred business type selection template 720.

Hereinafter, a process of recommending a region for an offline meeting will be described.

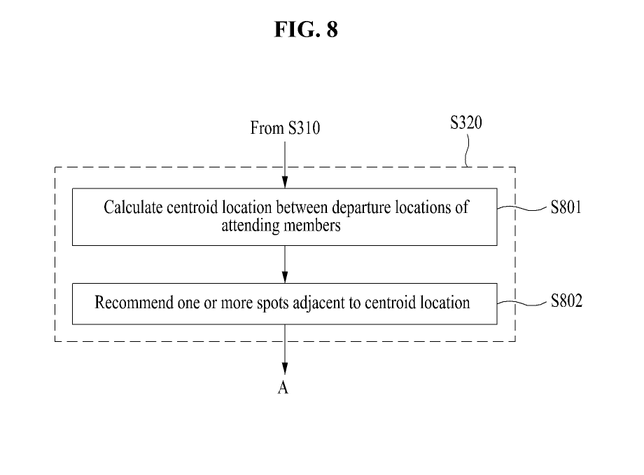

FIG. 8 is a flowchart illustrating a process of recommending regions for an offline meeting according to one example embodiment. Operations S801 and S802 of FIG. 8 are performed by the recommender 212 of FIG. 2.

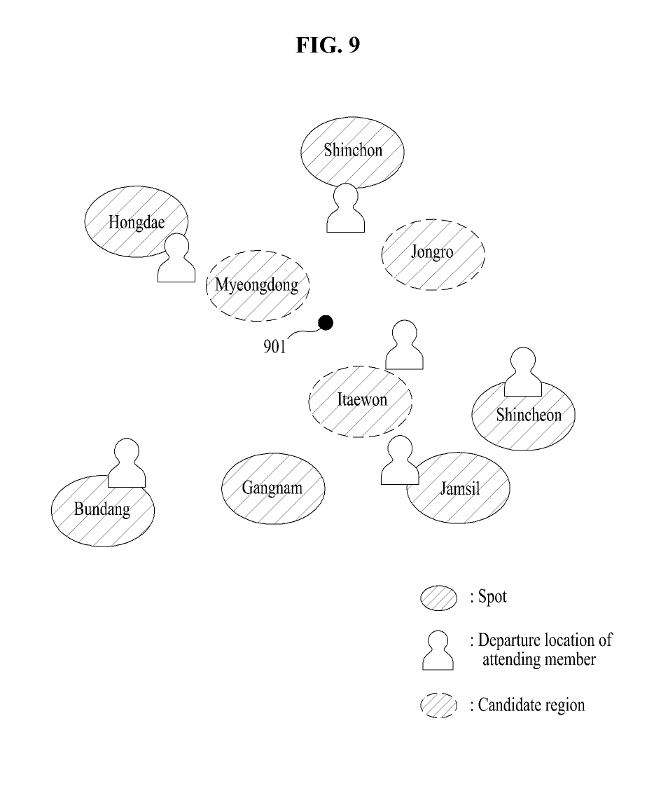

In operation S801, the recommender 212 calculates a centroid location between departure locations of attending members. As described above, the departure location of an attending member may indicate a current location of the attending member or another location set using a direct input method or an automatic input method. For example, the recommender 212 may calculate a centroid location with respect to the departure locations of attending members using an algorithm for calculating a centroid of a polygon. Referring to FIG. 9, when departure locations of attending members are dispersed, the recommender 212 may calculate a centroid location 901 based on the departure locations of all attending members.

In operation S802, the recommender 212 extracts one or more spots adjacent to the centroid location, includes the extracted one or more spots in a candidate region list, and recommends the candidate region list to the organizer of the offline meeting. For example, referring to FIG. 9, the recommender 212 may recommend a candidate region list including Myeongdong, Jongro, and Itaewon that are spots adjacent to the centroid location 901, based on the centroid location. Accordingly, the recommender 212 may recommend business types and stores based on a region selected by the organizer from the candidate region list.

As another example, the recommender 212 may determine an optimal point within the candidate region list based on at least one of a travel distance from a departure location to a spot of a candidate region and a travel distance from the spot of the candidate region to a return-home location for each attending member. For example, the recommender 212 may calculate a travel distance for each attending member from a corresponding spot with respect to each candidate region based on public transportation, for example, a subway and a bus, and may recommend a region having a smallest travel distance deviation with respect to attending members, among candidate regions. Similarly, the recommender 212 may calculate a travel distance from a corresponding spot to a return-home location of each attending member with respect to each candidate region and may recommend a region having a smallest travel distance deviation with respect to attending members, among candidate regions.

Hereinafter, a process of recommending geographical regions for an offline meeting based on public transportation will be described.

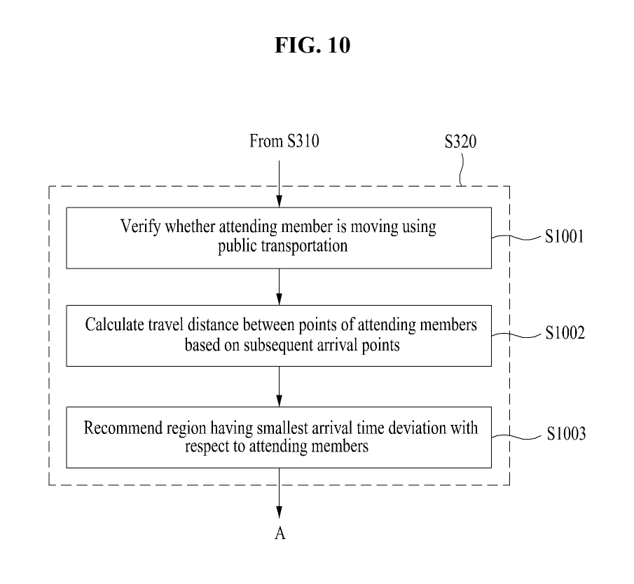

FIG. 10 is a flowchart illustrating a process of recommending geographical regions for an offline meeting based on public transportation according to an example embodiment. Operations S1001 through S1003 of FIG. 10 are performed by the recommender 212 of FIG. 2.

In operation S1001, the recommender 212 verifies whether an attending member is moving using public transportation. For example, the recommender 212 may verify whether the attending member is moving using public transportation by comparing a travel route of the attending member to the scheduled route of the public transportation.

In operation S1002, the recommender 212 extracts the shortest route by verifying the heading direction of each attending member and then calculating the travel distance between points at which the attending members are located based on subsequent arrival points. Here, if there is an attending member that needs to transfer to another route, the recommender 212 may apply the required transfer time on the public transportation and standby time.

In operation S1003, the recommender 212 recommends a region having the smallest arrival time deviation with respect to the attending members as an appropriate region of the offline meeting.

As another example, the recommender 212 may determine whether an attending member is moving using public transportation by comparing the travel route of the attending member to the scheduled route of the public transportation and whether the attending member is at a stop on the scheduled route. The recommender 212 may calculate a central point among the attending members using the public transportation and may recommend an appropriate region for the offline meeting by considering the minimum distance condition between the respective stops of the attending members on the scheduled routes of the public transportation based on an amount of time required to reach the central point and a heading direction.

Hereinafter, a process of recommending a business type for an offline meeting will be described.

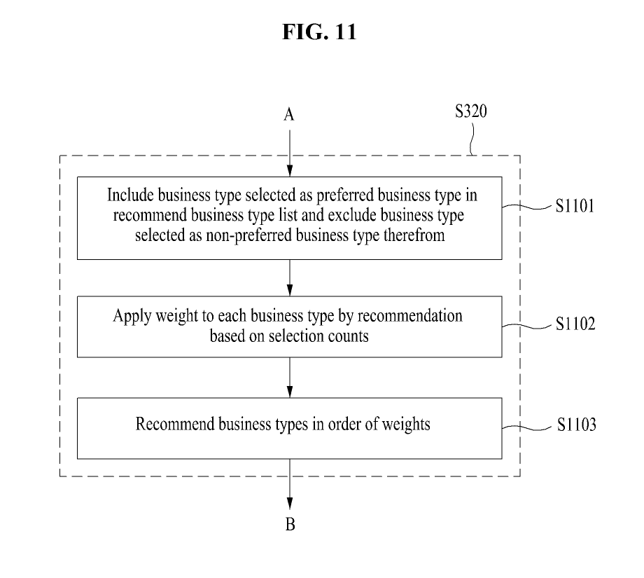

FIG. 11 is a flowchart illustrating a process of recommending business types for an offline meeting according to one example embodiment. Operations S1101 through S1103 of FIG. 11 are performed by the recommender 212 of FIG. 2.

In operation S1101, the recommender 212 includes a business type selected as a preferred business type in a recommend business type list, and excludes a business type selected as a non-preferred business type from the recommend business type list.

In operation S1102, the recommender 212 applies a weight to each business type included in the recommend business type list based on selection counts.

In operation S1103, the recommender 212 recommends business types included in the recommend business type list to an organizer of the offline meeting based on weights.

For example, it is assumed that a business type list is configured as illustrated in FIG. 7, and that one of the seven attending members has selected “pigs' feet/boiled pork” and “sashimi/roasted fish” as a non-preferred business type, six of the seven attending members have selected “soup/stew” as a preferred business type, three thereof have selected “charcoal-broiled meat” as a preferred business type, and five thereof have selected “pigs' feet/boiled pork” as a preferred business type. Accordingly, the recommender 212 may configure a recommend business type list using a business type selected as a preferred business type at least once and may exclude a business type selected as a non-preferred business type at least once from the recommend business type list. That is, among business types selected as the preferred business type, “pigs' feet/boiled pork” was also selected as the non-preferred business type and thus, the recommend business type list may be configured by initially excluding ‘pigs’ feet/boiled pork” from business types to be recommended and by using the remaining preferred business types, “soup/stew” and “charcoal-broiled meat”. The recommender 212 may assign a weight to each business type included in the recommend business type list based on counts selected as the preferred business type, and may recommend business types included in the recommend business type list to the organizer of the offline meeting in order of weights. The recommend business type list including “soup/stew” and “charcoal-broiled meat” may be recommended in order of “soup/stew”>“charcoal-broiled meat” based on weights according to selection counts.

The recommender 212 may recommend stores based on the business type selected by the organizer. Here, the business type selected by the organizer may be any one specific business type in the recommend business type list or the entire business types included in the recommend business type list.

As another example of a process of recommending business types for an offline meeting, the recommender 212 may verify season information corresponding to an appointed time of the offline meeting and may recommend a business type associated with the season of the year. For example, the recommender 212 may recommend a business type associated with the season of the year in which the offline meeting is to be held, such as restaurant serving “chicken soup with ginseng/boiled healthy soup” when the offline meeting is scheduled around the dog days of the year; a restaurant serving “grilled pork belly” when the offline meeting is scheduled on the grilled pork belly day, March 3, which is an unofficial anniversary; a Chinese restaurant when the offline meeting is scheduled on the black day, April 4, which is an unofficial anniversary; or a wine bar when the offline meeting is scheduled on the wine day, October 14, which is an unofficial anniversary.

Hereinafter, a process of recommending a store for an offline meeting will be described.

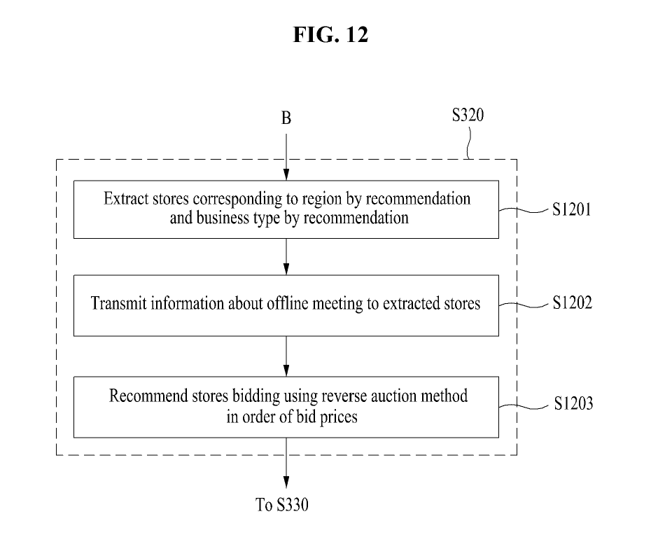

FIG. 12 is a flowchart illustrating a process of recommending stores for an offline meeting according to an example embodiment. Operations S1201 through S1203 of FIG. 12 are performed by the recommender 212 of FIG. 2.

In operation S1201, the recommender 212 extracts stores corresponding to the recommended region and business type. Here, when a plurality of regions and a plurality of business types are recommended, the recommender 212 may recommend stores corresponding to the region and the business type selected by an organizer of the offline meeting.

In operation S1202, the recommender 212 transmits information about the offline meeting to the extracted stores. For example, the recommender 212 may transmit a schedule, for example, the appointed time, and a scale, for example, the number of attending members, of the offline meeting to the extracted stores.

In operation S1203, the recommender 212 recommends stores that bid to have the offline meeting booked at their businesses using a reverse auction method, among the extracted stores to the organizer of the offline meeting in order of bid prices. In response to receiving information about the offline meeting, a corresponding store may transmit a response as to whether booking is available and may participate in a bid for the offline meeting when booking is available. Accordingly, the recommender 212 may separately display stores where booking is available, and may display a recommended store list in order of bid prices. When the organizer performs a conversion action which is a specific user action defined as valuable to business, such as use of information about a displayed store or a call connection thereto, charge may be made to the corresponding store.

According to the example embodiments, it is possible to recommend an appropriate region by collectively applying locations of attending members to an offline meeting. Further, it is possible to recommend business types in which preferences of the attending members are optimally applied and to recommend stores corresponding to a confirmed region and business type of the offline meeting.

Hereinafter, a process of managing an offline meeting at the recommended stores will be described.

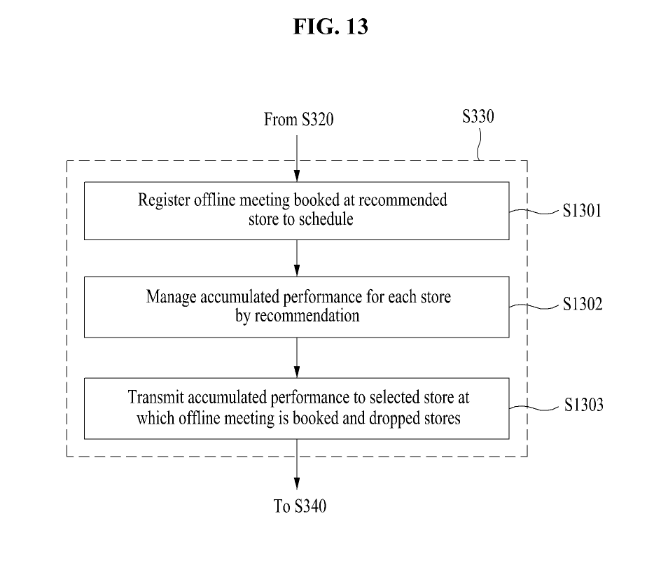

FIG. 13 is a flowchart illustrating a process of managing an offline meeting at a recommended store according to an example embodiment. Operations S1301 through S1303 of FIG. 13 are performed by the manager 213 of FIG. 2.

In operation S1301, when an offline meeting is booked at a specific store, the manager 213 registers and thereby manage the booked offline meeting to a schedule of a closed-type SNS. For example, when booking of the offline meeting is completed, the manager 213 may transmit information, for example, the name, the business type, the location, and the telephone number of the booked store to attending members, and may provide an alert about an appointed time of the offline meeting. Also, the manager 213 may offer rewards to the organizer of the offline meeting in response to payment and approval of the offline meeting.

In operation S1302, the manager 213 manages the accumulated performance associated with the offline meeting for each recommended store. For example, the manager 213 may manage, for each store, a recommendation count of the store displayed as a recommended place of the offline meeting, a selection count of the store booked as a place of the offline meeting, and a drop count acquired by subtracting the selection counts from the recommendation counts.

In operation S1303, the manager 213 distinguishes a selected store at which the offline meeting is booked from dropped stores among the recommended stores, and transmits information including accumulated performance, for example, the recommendation counts, the selection counts, and the drop accounts for each store. Here, the manager 213 may transmit schedule information, for example, an appointed time, of the offline meeting, subscriber information, for example, a telephone number of an organizer, and accumulated performance to the selected store. The manager 213 may transmit, to the dropped stores, drop information including a notice that the store has been dropped for the offline meeting, and a bid price, a business type, and accumulated performance of the selected store.

According to the example embodiments, it is possible to manage an offline meeting booked at a store recommended through a meeting appointment function as an in-service schedule, and to continuously manage accumulated performance of a selected store and a dropped store.

Hereinafter, a process of sharing profits made by store recommendation will be described.

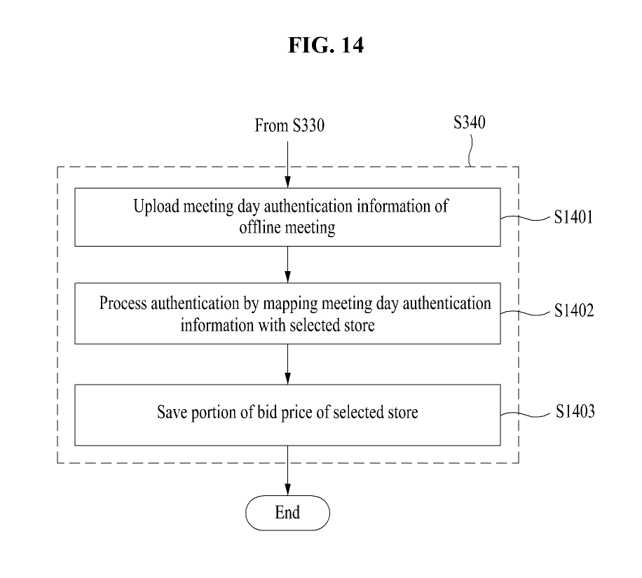

FIG. 14 is a flowchart illustrating a process of sharing profits made in response to recommending a store according to one example embodiment. Operations S1401 through S1403 of FIG. 14 are performed by the profit sharer 214 of FIG. 2.

In operation S1401, the profit sharer 214 receives meeting day authentication information uploaded by an organizer of an offline meeting or an attending member. Here, the meeting day authentication information may use a payment authorization message of a store, using, for example, a short messaging service (SMS), a photo including location information of the store using, for example, a global positioning system (GPS), a quick response (QR) code issued from the store, or a photo including the QR code.

In operation S1402, the profit sharer 214 processes authentication of the offline meeting by mapping the meeting day authentication information to a selected store. That is, the profit sharer 214 may authenticate whether the offline meeting is substantially made at the selected store using a method of mapping a store name included in the payment authorization message to the selected store, a method of mapping location information included in a photo to the selected store, or a method of mapping a QR code to the selected store. Here, information about the offline meeting and information used for authentication, for example, a scale of the offline meeting such as the number of people attending the offline meeting or the number of tables used for the offline meeting, a payment amount included in the payment authorization message, and a meeting authentication photo may be applied as statistics and thereby displayed.

In operation S1403, when authentication of the offline meeting is completed, the profit sharer 214 may save a portion of a bid price of the selected store in at least one of the organizer of the offline meeting and a closed-type SNS having set the offline meeting.

According to some example embodiments, it is possible to activate a service utilization by sharing advertising profits acquired from store recommendation with an organizer of an offline meeting or a closed-type SNS.

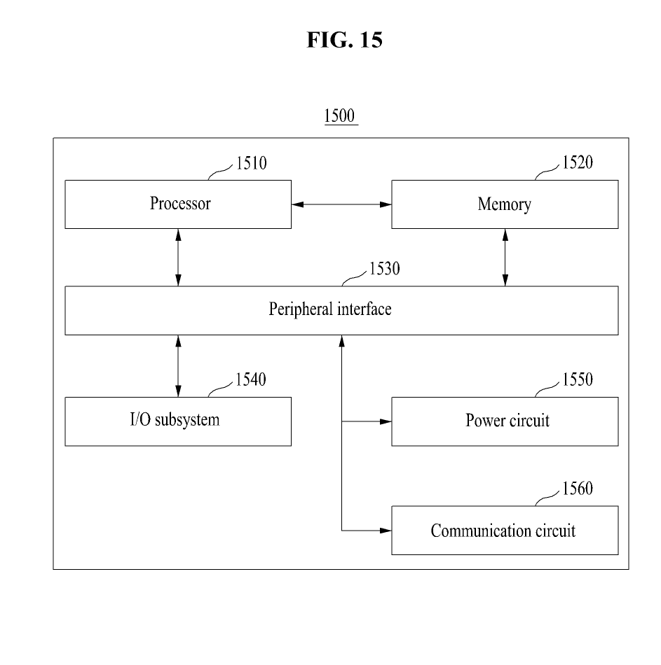

FIG. 15 is a block diagram illustrating a configuration of a computer system according to one example embodiment. Referring to FIG. 15, the computer system 1500 may include at least one processor 1510, a memory 1520, a peripheral interface 1530, an I/O subsystem 1540, a power circuit 1550, and a communication circuit 1560. Here, the computer system 1500 may correspond to a terminal used by a user that is a member of a closed-type SNS.

The memory 1520 includes, for example, a high-speed random access memory (HSRAM), a magnetic disk, a static random access memory (SRAM), a dynamic RAM (DRAM), read only memory (ROM), a flash memory, and a non-volatile memory. The memory 1520 may include a software module, an instruction set, or a variety of data required for an operation of the computer system 1500. Here, an access from another component such as the processor 1510 and the peripheral interface 1530 to the memory 1520 may be controlled by the processor 1510.

The peripheral interface 1530 couples an input device and/or output device of the computer system 1500 with the processor 1510 and the memory 1520. The processor 1510 may perform a variety of functions for the computer system 1500 and process data by executing the software module or the instruction set stored in the memory 1520.

The I/O subsystem 1540 couples various I/O peripheral devices with the peripheral interface 1530. For example, the I/O subsystem 1540 may include a controller for coupling the peripheral interface 1530 and a peripheral device such as a monitor, a keyboard, a mouse, a printer, and a touch screen or a sensor depending on a necessity. The I/O peripheral devices may be coupled with the peripheral interface 1530 without using the I/O subsystem 1540.

The power circuit 1550 supplies a power to all of or a portion of components of a terminal. For example, the power circuit 1550 may include a power management system, at least one power source such as a battery and alternating circuit (AC), a charge system, a power failure detection circuit, a power converter or inverter, a power status indicator, or other components for creating, managing and distributing power.

The communication circuit 1560 enables communication with another computer system using at least one external port. Alternatively, as described above, the communication circuit 1560 may enable communication with another computer system by including a radio frequency (RF) circuit and thereby transmitting and receiving an RF signal known as an electromagnetic signal.

The example embodiment of FIG. 15 is only an example of the computer system 1500. The computer system 1500 may have a configuration or an arrangement for omitting a portion of the components illustrated in FIG. 15, further including components not illustrated in FIG. 15, or coupling two or more components. For example, a computer system for a communication terminal of a mobile environment may further include a touch screen, a sensor, and the like, in addition to the components of FIG. 15. A circuit for RF communication using a variety of communication methods, for example, wireless fidelity (Wi-Fi), 3rd generation (3G), long term evolution (LTE), Bluetooth, near field communication (NFC), and ZigBee, may be included in the communication circuit 1560. Components includable in the computer system 1500 may be configured as hardware that includes an integrated circuit specified for at least one signal processing or application, software, or a combination of hardware and software.

Although the example embodiments are described with reference to screens of FIG. 1 and FIGS. 5 through 7 executed on a mobile terminal, they are proposed to help the understanding of the present disclosure and the present disclosure is not limited thereto. The present disclosure may be performed in a website environment of a general PC.

The methods according to the example embodiments may be configured in a program instruction form executable through various computer systems and thereby recorded in non-transitory computer-readable media.

In particular, a program according to the example embodiments may be configured as a PC-based program or an application exclusive for a mobile terminal. A closed-type SNS application according to the example embodiments may be configured in a form of an independently operating program or an in-app form of a desired (or, alternatively predetermined) application to be operable on the desired (or, alternatively predetermined) application.

Also, the methods according to the example embodiments may be performed in such a manner that an application associated with a server system that provides a closed-type SNS including a meeting place recommendation service controls a user terminal. For example, the application may include a module configured to control the user terminal to activate a meeting appointment function capable of setting an offline meeting between a plurality of users having set a relationship on the closed-type SNS, and a module configured to control the user terminal to display a region, a business type, and a store for the offline meeting based on location information and preference information of the plurality of users through the meeting appointment function. Further, the application may be installed in the user terminal through a file provided from a file distribution system. For example, the file distribution system may include a file transmitter (not shown) configured to transmit the file in response to a request of the user terminal.

According to the example embodiments, it is possible to recommend an appropriate business type and store by applying locations and preferences of expected attending members when making an appointment for an offline meeting through a closed-type SNS. Also, according to the example embodiments, it is possible to extract a meeting related keyword from a chat room or a bulletin board on a closed-type SNS and automatically push a meeting appointment function. Also, according to the example embodiments, it is possible to determine stores by recommendation and displaying the stores in order of bid prices using a reverse auction method. Also, according to the example embodiments, it is possible to share a portion of a bid price with an organizer of a meeting or a closed-type SNS in response to an occurrence of sales.

The constituent elements or units described in FIG. 2 may be implemented using hardware components, software components, or a combination thereof. For example, the hardware components may include microcontrollers, memory modules, sensors, amplifiers, band-pass filters, analog to digital converters, and processing devices, or the like. A processing device may be implemented using one or more hardware device(s) configured to carry out and/or execute program code by performing arithmetical, logical, and input/output operations. The processing device(s) may include a processor, a controller and an arithmetic logic unit, a digital signal processor, a microcomputer, a field programmable array, a programmable logic unit, a microprocessor or any other device capable of responding to and executing instructions in a defined manner. The processing device(s) may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors, multi-core processors, distributed processing, or the like.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, and/or computer storage medium or device. The software also may be distributed over network coupled computer systems so that the software is stored and executed in a distributed fashion. The software and data may be stored by one or more computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of some example embodiments, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described embodiments, or vice versa.

It should be understood that the example embodiments described herein should be considered in a descriptive sense only and not for purposes of limitation. Descriptions of features or aspects within each device or method according to the example embodiments should typically be considered as available for other similar features or aspects in other devices or methods according to the example embodiments. While some example embodiments have been particularly shown and described, it will be understood by one of ordinary skill in the art that variations in form and detail may be made therein without departing from the spirit and scope of the claims.

What is claimed is:

1. A meeting place recommendation method performed by a meeting place recommendation system, wherein the meeting place recommendation system comprises a processor and the processor comprises a provider and a recommender, the meeting place recommendation method comprising:
providing, by the provider included in the processor, a meeting appointment function for setting an offline meeting between a plurality of users having set a relationship on a closed-type social network service (SNS); and
recommending, by the recommender included in the processor, a region, a business type, and a store for the offline meeting based on location information and preference information of the plurality of users through the meeting appointment function.

2. The meeting place recommendation method of claim 1, wherein the providing comprises suggesting use of the meeting appointment function to a user having input a meeting related keyword in response to extracting the meeting related keyword from keywords input on a chat room or a bulletin board on the closed-type SNS.

3. The meeting place recommendation method of claim 1, wherein the providing comprises providing each user with the meeting appointment function that includes a function of inputting attendance information including a departure location, a preferred business type, and a non-preferred business type.

4. The meeting place recommendation method of claim 1, wherein the recommending comprises recommending the region, the business type, and the store for the offline meeting based on location information and preference information of an expected attendee having registered an intent to attend the offline meeting among the plurality of users.

5. The meeting place recommendation method of claim 1, wherein the recommending comprises recommending the region based on a current location of each user or an expected location corresponding to an appointed time of the offline meeting extracted from a location record log of each user, with respect to the plurality of users.

6. The meeting place recommendation method of claim 1, wherein the recommending comprises calculating a centroid location between departure locations with respect to the users and recommending one or more spots adjacent to the centroid location.

7. The meeting place recommendation method of claim 6, wherein the recommending comprises recommending one of spots based on at least one of a travel distance from a departure location of each user to a spot and a travel distance from the spot to a return-home location of each user.

8. The meeting place recommendation method of claim 1, wherein the recommending comprises receiving a selection from each user on a preferred business type and a non-preferred business type, excluding non-preferred business types, and recommending preferred business types in order of weights based on selection counts.

9. The meeting place recommendation method of claim 1, wherein the recommending comprises recommending the business type based on season information corresponding to an appointed time of the offline meeting.

10. The meeting place recommendation method of claim 1, wherein the recommending comprises extracting stores corresponding to the recommended region and the recommended business type and displaying the extracted stores in order of bid prices.

11. The meeting place recommendation method of claim 10, wherein the recommending comprises transmitting information about the offline meeting to the extracted stores, and displaying a store having applied for a bid associated with the offline meeting using a reverse auction method.

12. The meeting place recommendation method of claim 10, wherein the recommending comprises transmitting information about the offline meeting to the extracted stores, receiving a response regarding whether booking for the offline meeting is available, and displaying stores at which booking for the offline meeting is available.

13. The meeting place recommendation method of claim 10, wherein the processor further comprises a manager, and the meeting place recommendation method further comprises:
registering, by the manager included in the processor, the offline meeting as a schedule associated with the closed-type SNS in response to the offline meeting being booked at a desired store.

14. The meeting place recommendation method of claim 10, wherein the processor further comprises a manager, and the meeting place recommendation method further comprises:
transmitting, by the manager included in the processor, information about the offline meeting to a store at which the offline meeting is booked among the displayed stores, and transmitting, to remaining stores, drop information including a bid price of the store at which the offline meeting is booked.

15. The meeting place recommendation method of claim 10, wherein the processor further comprises a profit sharer, and the meeting place recommendation method further comprises:
sharing, by the profit sharer included in the processor, a portion of a bid price of a store at which the offline meeting is booked with at least one of the closed-type SNS and an organizer having set the offline meeting.

16. The meeting place recommendation method of claim 15, wherein the sharing comprises saving the portion of the bid price in response to uploading meeting day authentication information that maps the store at which the offline meeting is booked.

17. A non-transitory computer-readable medium storing an instruction to control a computer system to provide a closed-type social network service (SNS), wherein the instruction controls the computer system to perform the steps comprising:
providing a meeting appointment function for setting an offline meeting between a plurality of users having set a relationship on the closed-type SNS; and
recommending a region, a business type, and a store for the offline meeting based on location information and preference information of the plurality of users through the meeting appointment function.

18. A meeting place recommendation system comprising:
a processor;
a memory; and
a network interface,
wherein the processor comprises:
a provider configured to provide a meeting appointment function for setting an offline meeting between a plurality of users having set a relationship on a closed-type social network service (SNS); and
a recommender configured to recommend a region, a business type, and a store for the offline meeting based on location information and preference information of the plurality of users through the meeting appointment function.

19. The meeting place recommendation system of claim 18, wherein the provider is configured to suggest use of the meeting appointment function to a user having input a meeting related keyword in response to extracting the meeting related keyword from keywords input on a chat room or a bulletin board on the closed-type SNS.

20. The meeting place recommendation system of claim 18, wherein the provider is configured to provide each user with the meeting appointment function that includes a function of inputting attendance information including a departure location, a preferred business type, and a non-preferred business type.
